(19) United States
(12) Patent Application Publication
(10) Pub. No.: US 2010/0033071 A1
(43) Pub. Date: Feb. 11, 2010

(54) THERMAL MANAGEMENT OF LED ILLUMINATION DEVICES WITH SYNTHETIC JET EJECTORS

(75) Inventors: Samuel N. Heffington, Austin, TX (US); Raghavendran Mahalingam, Austin, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Nuventix Inc.

(21) Appl. No.: 12/503,181

(22) Filed: Jul. 15, 2009

Related U.S. Application Data
(60) Provisional application No. 61/134,984, filed on Jul. 15, 2008.

(51) Int. Cl. H01J 61/52

(52) U.S. Cl. 313/46

(57) ABSTRACT

An illumination device (b1-01) is provided which comprises a housing (b1-03) equipped with an aperture (b1-37), first (b1-33) and second (b1-35) diaphragms disposed in said housing and in fluidic communication with said aperture, and an LED (b1-15) disposed between said first and second diaphragms.

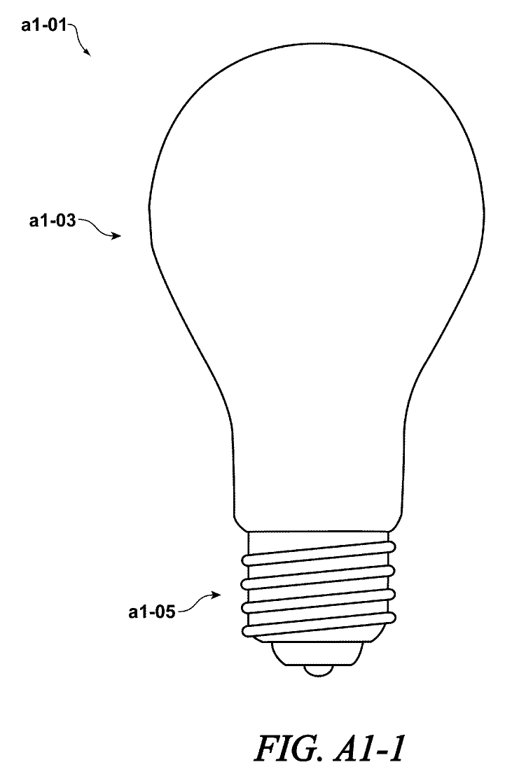

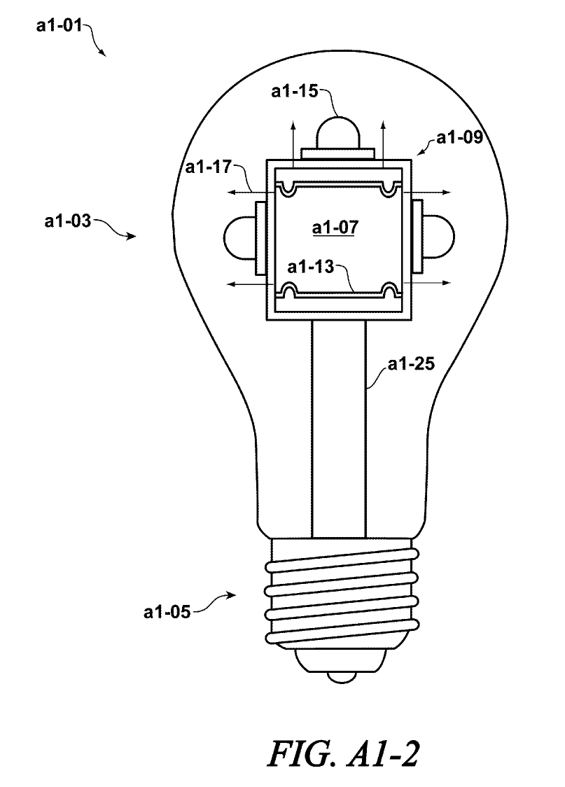

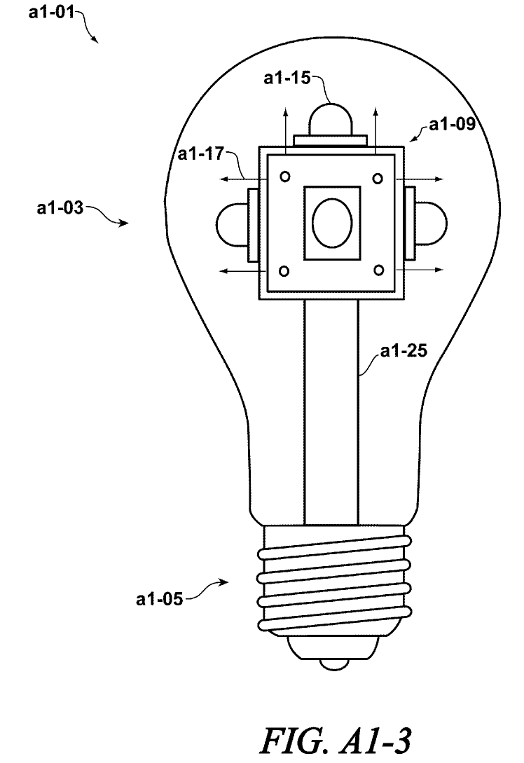

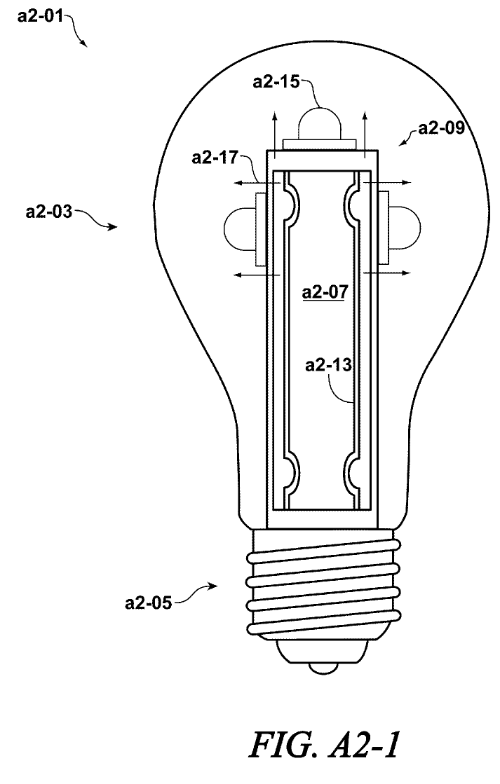

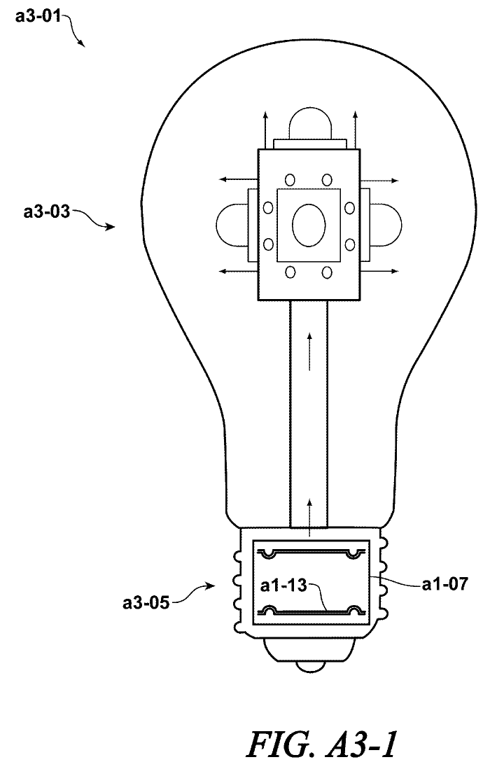

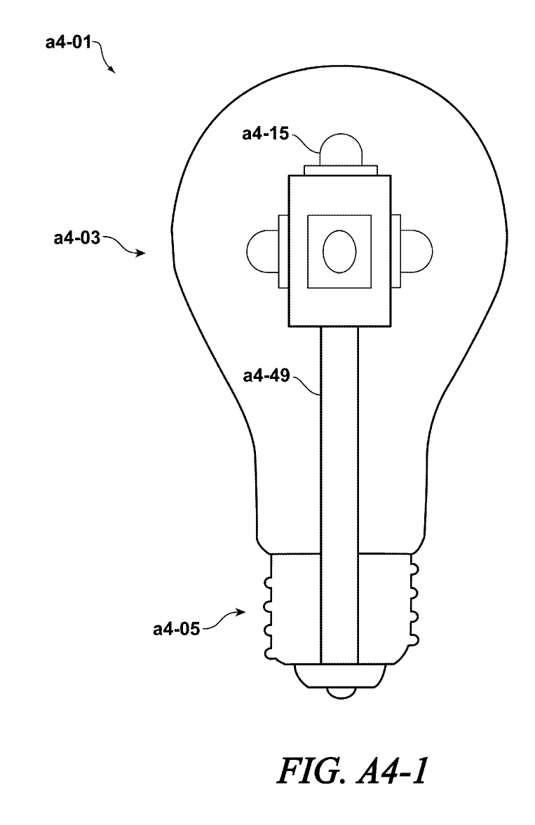

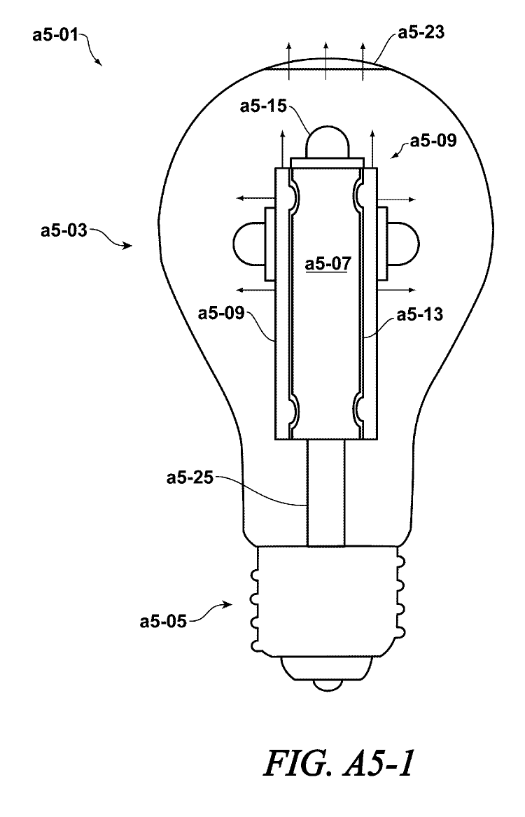

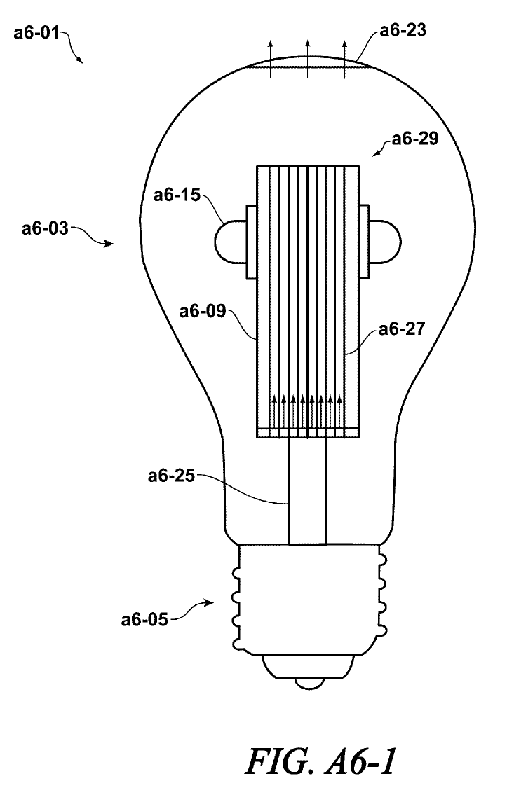

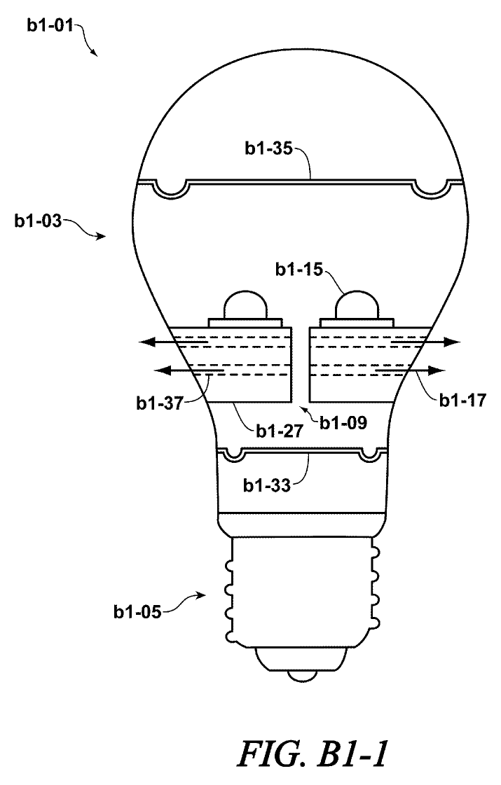

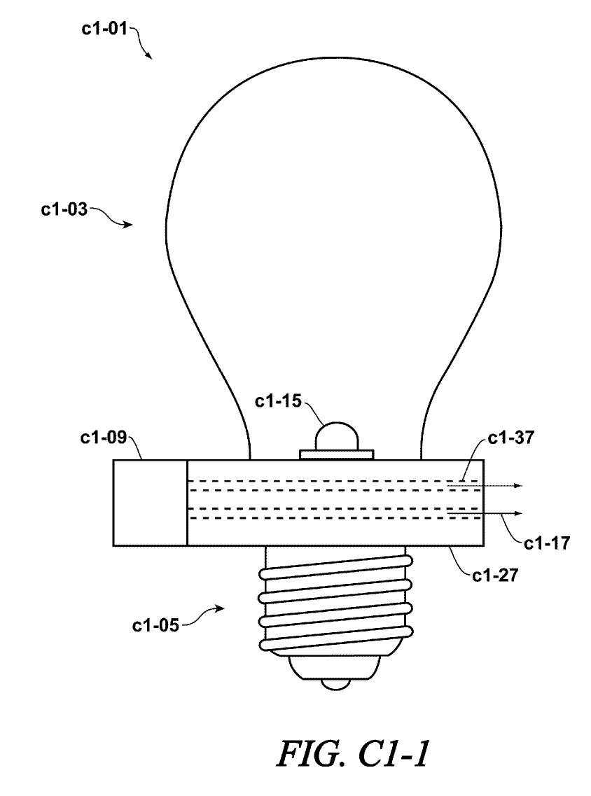

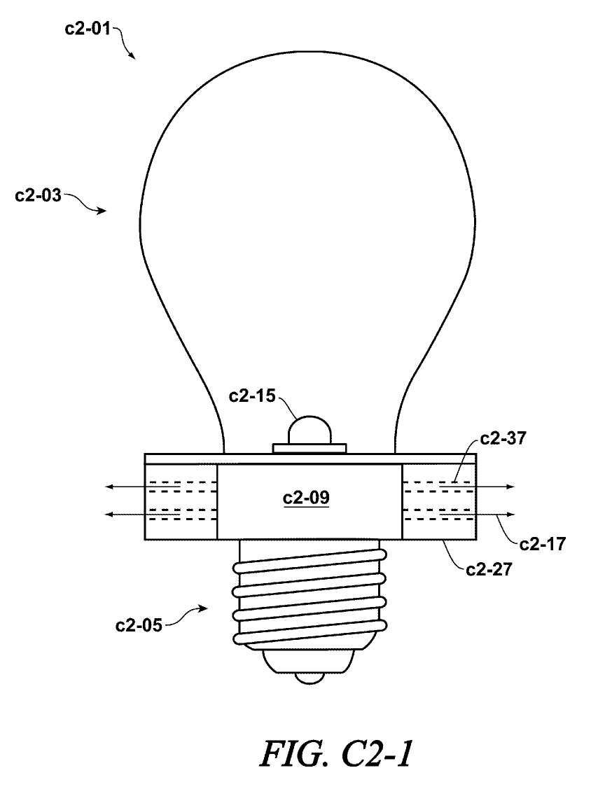

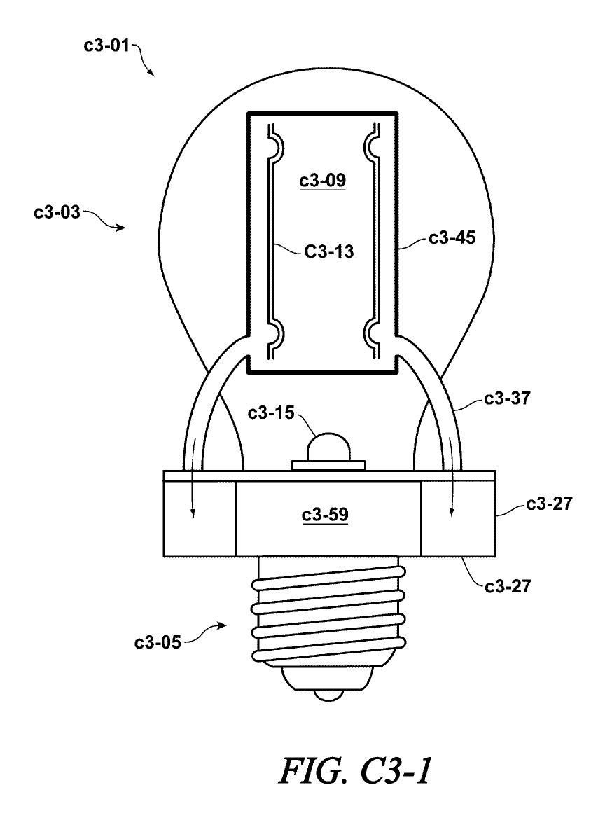

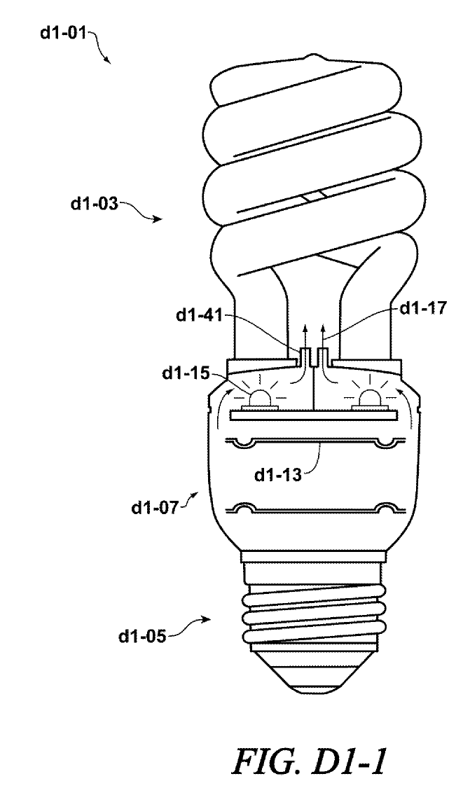

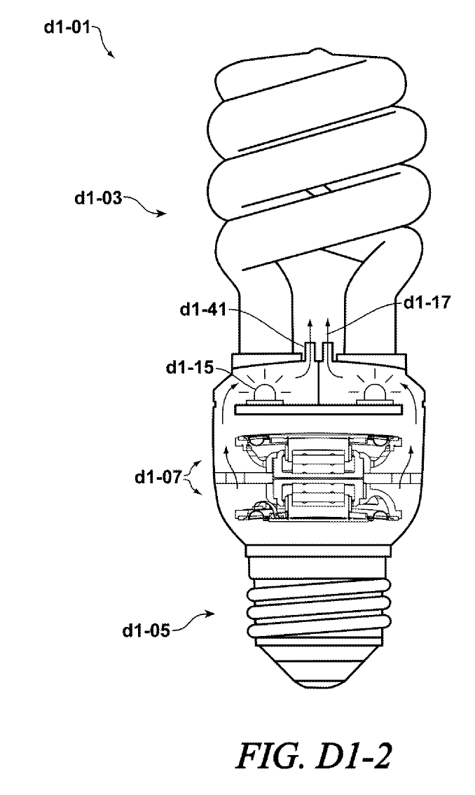

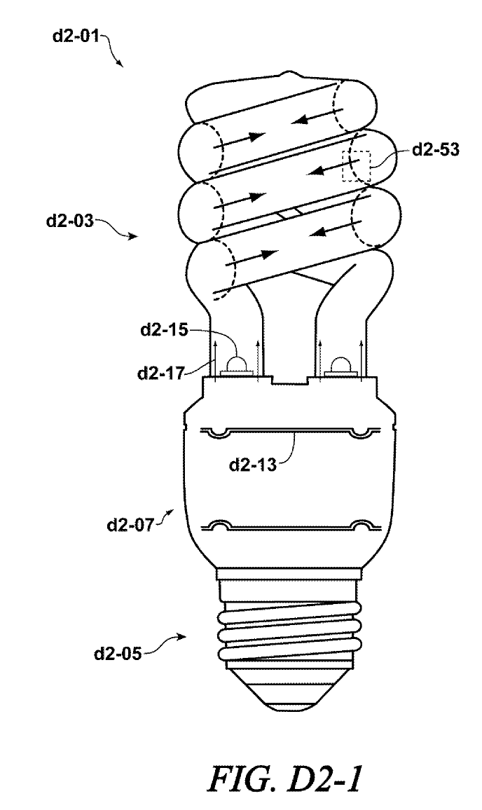

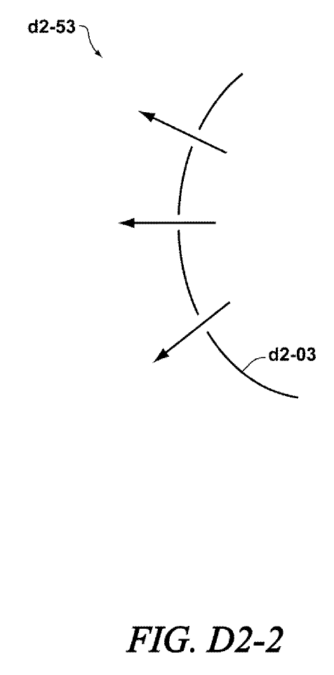

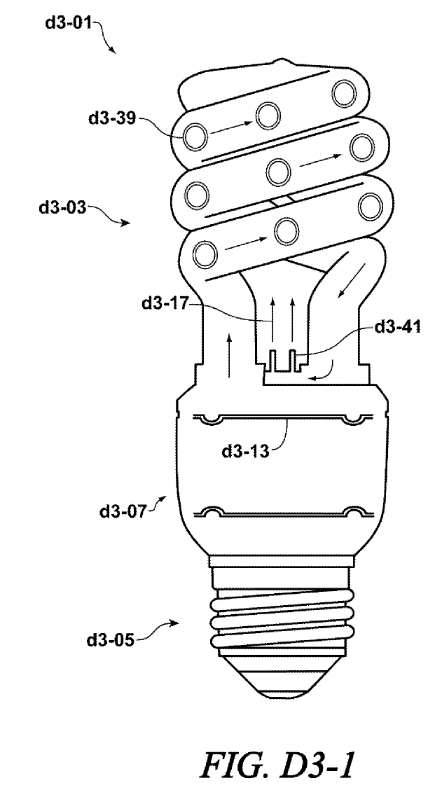

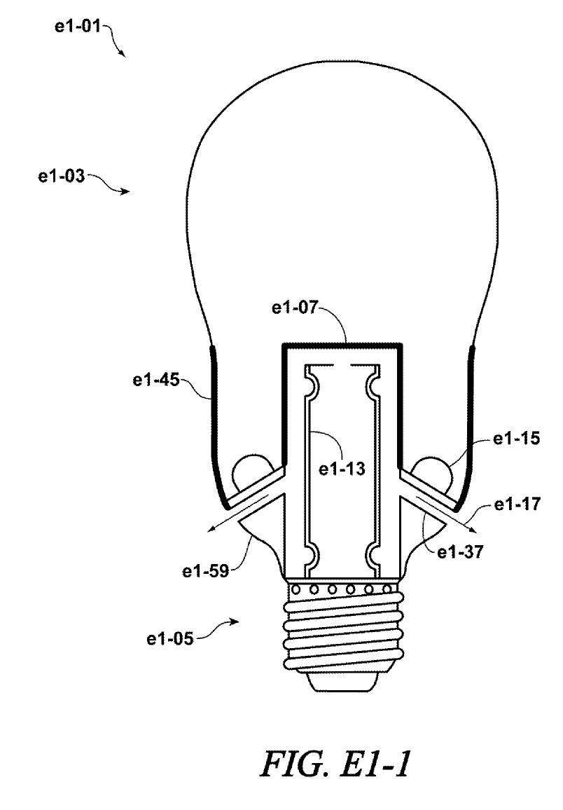

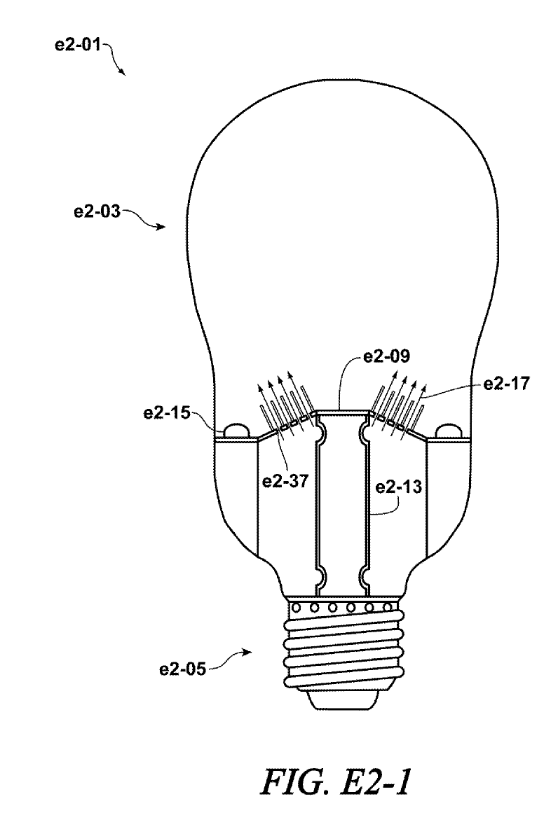

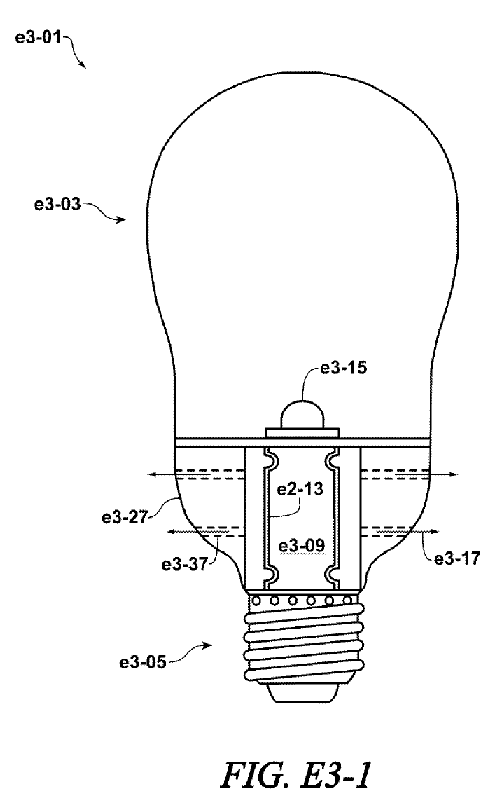

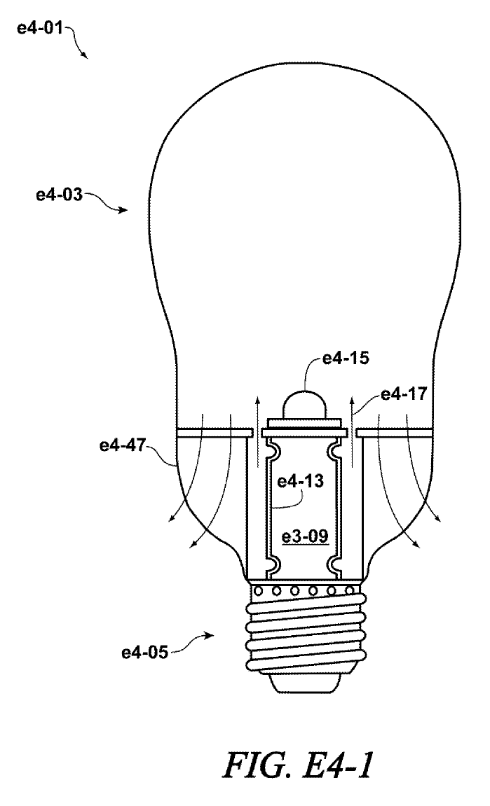

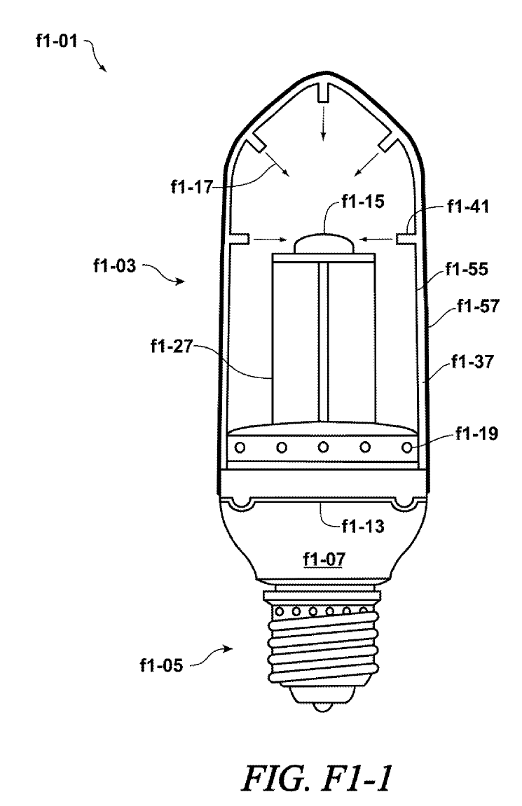

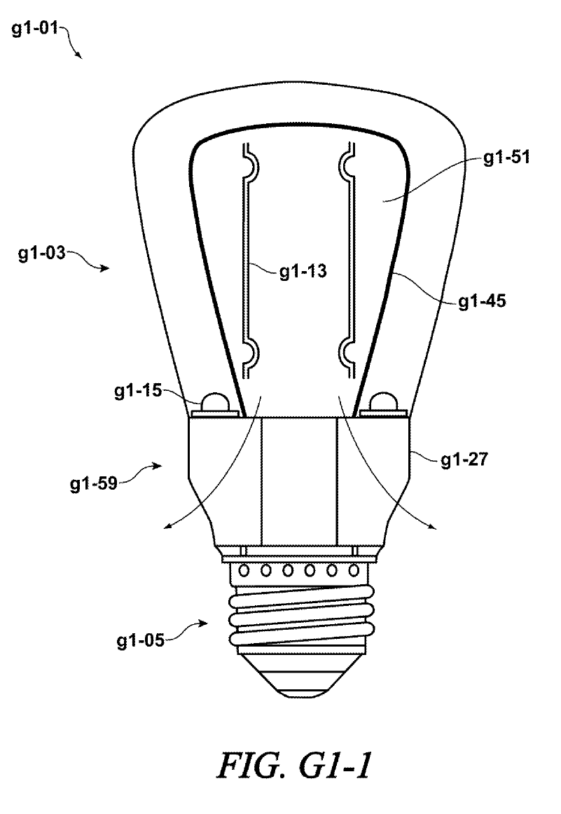

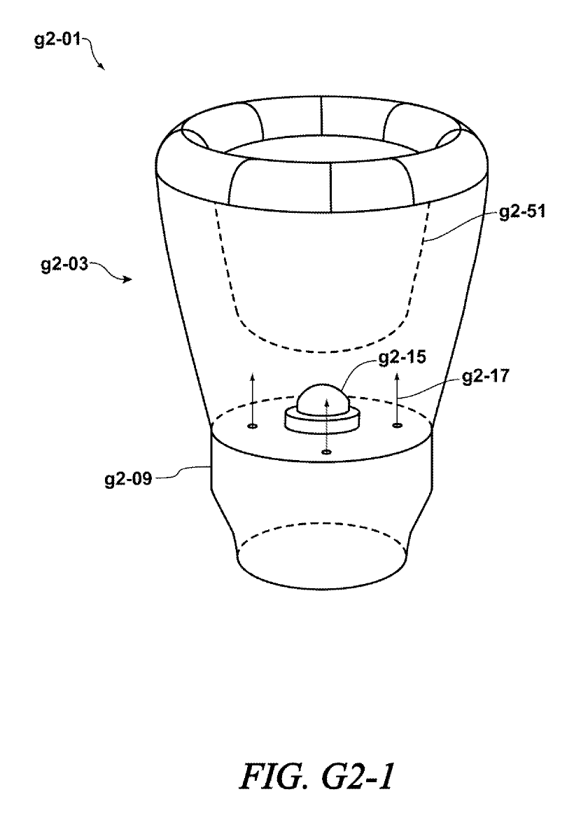

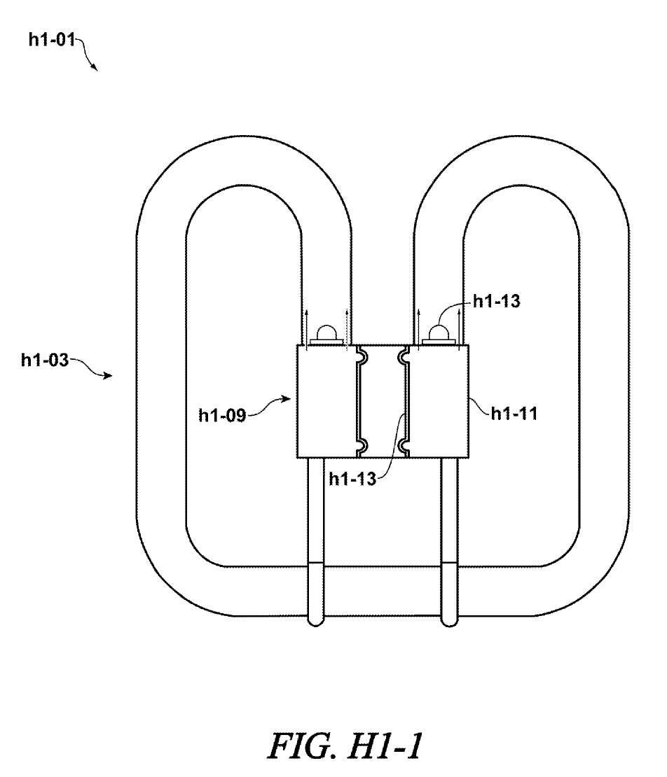

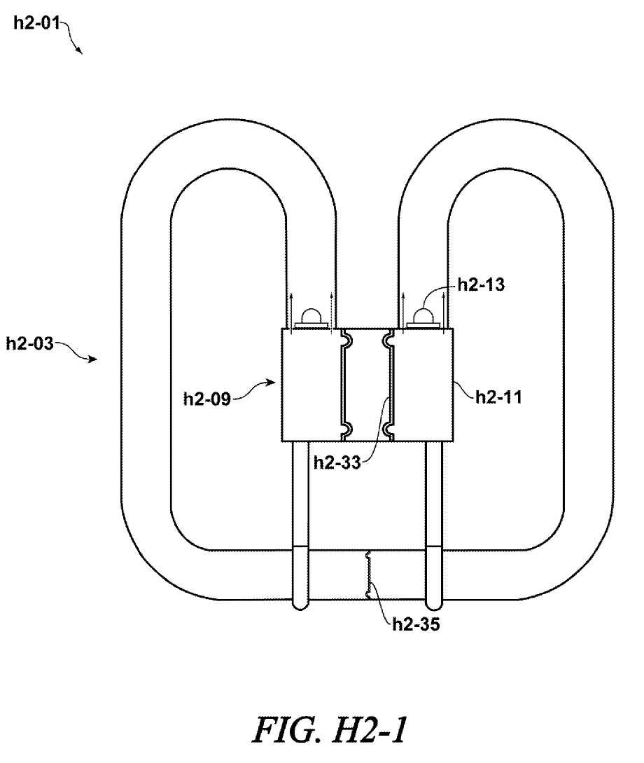

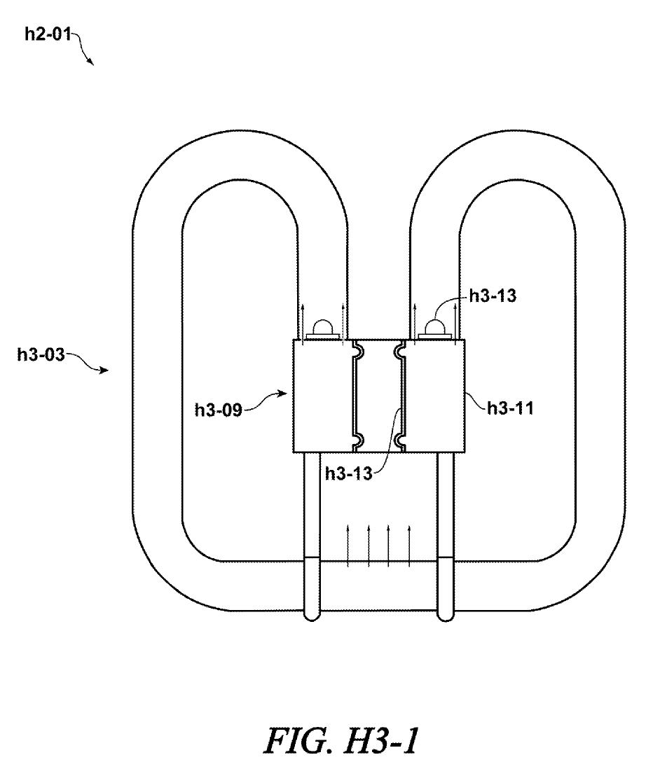

### FIELD OF THE DISCLOSURE

The present disclosure relates generally to the thermal management of LED illumination devices, and more particularly to the thermal management of LED illumination devices with synthetic jet ejectors.

### BACKGROUND OF THE DISCLOSURE

A variety of thermal management devices are known to the art, including conventional fan based systems, piezoelectric systems, and synthetic jet actuators. The latter type of system has emerged as a highly efficient and versatile solution where thermal management is required at the local level. Frequently, synthetic jet actuators are utilized in conjunction with a conventional fan based system. In such hybrid systems, the fan based system provides a global flow of fluid through the device being cooled, and the synthetic jet ejectors provide localized cooling for hot spots and also augment the global flow of fluid through the device by perturbing boundary layers.

Various examples of synthetic jet actuators are known to the art. Some examples include those disclosed in U.S. 20070141453 (Mahalingam et al.) entitled “Thermal Management of Batteries using Synthetic Jets”; U.S. 20070127210 (Mahalingam et al.), entitled “Thermal Management System for Distributed Heat Sources”; 20070119575 (Glezer et al.), entitled “Synthetic Jet Heat Pipe Thermal Management System”; 20070119573 (Mahalingam et al.), entitled “Synthetic Jet Ejector for the Thermal Management of PCI Cards”; 20070096118 (Mahalingam et al.), entitled “Synthetic Jet Cooling System for LED Module”; 20070081027 (Beltran et al.), entitled “Acoustic Resonator for Synthetic Jet Generation for Thermal Management”; and 20070023169 (Mahalingam et al.), entitled “Synthetic Jet Ejector for Augmentation of Pumped Liquid Loop Cooling and Enhancement of Pool and Flow Boiling”.

### BRIEF DESCRIPTION OF THE DRAWINGS

FIG. A1-1 is an illustration of an illumination device in accordance with the teachings herein.

FIG. A1-2 is an illustration of an illumination device in accordance with the teachings herein.

FIG. A1-3 is an illustration of an illumination device in accordance with the teachings herein.

FIG. A2-1 is an illustration of an illumination device in accordance with the teachings herein.

FIG. A3-1 is an illustration of an illumination device in accordance with the teachings herein.

FIG. A4-1 is an illustration of an illumination device in accordance with the teachings herein.

FIG. A5-1 is an illustration of an illumination device in accordance with the teachings herein.

FIG. A6-1 is an illustration of an illumination device in accordance with the teachings herein.

FIG. B1-1 is an illustration of an illumination device in accordance with the teachings herein.

FIG. C1-1 is an illustration of an illumination device in accordance with the teachings herein.

FIG. C2-1 is an illustration of an illumination device in accordance with the teachings herein.

FIG. D1-1 is an illustration of an illumination device in accordance with the teachings herein.

FIG. D1-2 is an illustration of an illumination device in accordance with the teachings herein.

FIG. D2-1 is an illustration of an illumination device in accordance with the teachings herein.

FIG. D2-2 is an illustration of a portion of the housing structure of the device of FIG. D2-1.

FIG. D3-1 is an illustration of an illumination device in accordance with the teachings herein.

FIG. E1-1 is an illustration of an illumination device in accordance with the teachings herein.

FIG. E2-1 is an illustration of an illumination device in accordance with the teachings herein.

FIG. E3-1 is an illustration of an illumination device in accordance with the teachings herein.

FIG. E4-1 is an illustration of an illumination device in accordance with the teachings herein.

FIG. F1-1 is an illustration of an illumination device in accordance with the teachings herein.

FIG. G1-1 is an illustration of an illumination device in accordance with the teachings herein.

FIG. G2-1 is an illustration of an illumination device in accordance with the teachings herein.

FIG. H1-1 is an illustration of an illumination device in accordance with the teachings herein.

FIG. H2-1 is an illustration of an illumination device in accordance with the teachings herein.

FIG. H3-1 is an illustration of an illumination device in accordance with the teachings herein.

### DETAILED DESCRIPTION

The devices and methodologies disclosed herein may be further understood with reference to the particular, non-limiting embodiments depicted in FIGS. A1-1 through G2-1. In these figures, like elements have been given like numerical identifiers. A listing of the numerical identifiers is attached hereto as APPENDIX A.

With reference to FIGS. A1-1 to A1-3, a first embodiment of an LED light fixture in accordance with the teachings herein is disclosed. As seen therein, the light fixture a1-01 comprises a light-emitting portion a1-03 which emits light, and a connector a1-05 which connects the light fixture a1-01 to a light fixture. In the particular embodiment depicted, the connector a1-05 is a threaded connector that rotatingly engages a complimentary shaped socket in an electrical outlet (not shown), though it will be appreciated that the light fixtures disclosed herein are not necessarily limited to use in conjunction with such an outlet.

### Electrical Outlets

The various embodiments of light fixtures disclosed herein may be equipped with various electrical connectors. These include, without limitation, threaded connectors that rotatingly engage complimentary shaped sockets in an electrical outlet; prong connectors, which may be male or female, and which mate with complimentary shaped prongs or receptacles in an electrical outlet; cord connectors; and the like. The choice of connector may vary from one application to another and may depend, for example, on the wattage output of the light fixture and other such considerations as are known to the art. It will be understood, however, that while embodiments of light fixtures may have been disclosed or illustrated herein as having a particular connector type, any other suitable connector, including those described above, may be substituted where suitable for a particular application.

### Bulb Coatings/Pigments

The various embodiments of light fixtures disclosed herein may be equipped with various bulbs. These bulbs, or any portion thereof, may be clear, opaque, specularly or diffusively transmissive or reflective, polarizing, mirrored, colored, or any combination of the foregoing. For example, in some embodiments, the bulb may be equipped with a film or pigment which provides the light fixture with a desired optical footprint, or which extracts

These bulbs may also be equipped with any of the various types of phosphors as are known to the art, or combinations of such phosphors.

### Bulb Geometries

The various embodiments of light fixtures disclosed herein may be equipped with bulbs having various geometries.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### Appendix A

### (Parts List)

01: Light Source

03: Housing

05: Electrical Connector Module

07: Synthetic Jet Actuator

09: Synthetic Jet Ejector

11: Actuator Housing

13: Diaphragm

15: LED

17: Synthetic Jet

19: Internal Aperture

21: External Aperture

23: External Vent

25: Pedestal

27: Heat Fin

29: Synthetic Jet Ejector/Heat Sink Combination

31: LED Support Structure

33: Active Diaphragm

35: Passive Diaphragm

37: Channel

39: Externally Mounted LED

41: Nozzle

43: Synthetic Jet Actuator Support Structure

45: Reflective Material

47: Porous Medium

49: Heat Pipe

51: Internal Chamber

53: Region

55: Internal Housing Element

57: External Housing Element

59: Heat Sink

1. An illumination device, comprising:
a housing;
a pedestal disposed in said housing;
a synthetic jet ejector supported by said pedestal; and
at least one LED supported by said synthetic jet ejector.

2. The illumination device of claim 1, wherein said synthetic jet ejector comprises first and second diaphragms.

3. The illumination device of claim 1, wherein said synthetic jet ejector has first and second opposing surfaces having first and second LEDs, respectively, disposed thereon.

4. The illumination device of claim 1, wherein said synthetic jet ejector has third and fourth opposing surfaces having third and fourth LEDs, respectively, disposed thereon.

5. The illumination device of claim 1, wherein said synthetic jet ejector is essentially polyhedral in shape, wherein said synthetic jet ejector is attached to said pedestal across a first face of said polyhedron, and wherein at least one LED is disposed on each of the remaining faces of said polyhedron.

6. The illumination device of claim 5, wherein said polyhedron has six faces.

7. The illumination device of claim 5, wherein said polyhedron has five faces.

8. The illumination device of claim 5, wherein said polyhedron has four faces.

9. The illumination device of claim 1, wherein said LED is supported on a surface of said synthetic jet ejector, and wherein said synthetic jet ejector is adapted to emit a plurality of synthetic jets across said surface.

10. The illumination device of claim 1, wherein said LED is supported on a surface of said synthetic jet ejector, and wherein said synthetic jet ejector is adapted to emit a plurality of synthetic jets across said surface and adjacent to said LED.

11. The illumination device of claim 1, wherein said housing is diffusely transmissive.

12. The illumination device of claim 1, wherein said synthetic jet ejector has first and second diaphragms, wherein said housing has a longitudinal axis, and wherein said first and second diaphragms are oriented parallel to said longitudinal axis.

13. The illumination device of claim 1, further comprising:
a threaded connector adapted to rotatingly engage said illumination device to a source of electricity.

14. The illumination device of claim 10, wherein said housing is bulbous in shape.

15. The illumination device of claim 1, wherein said housing has at least one aperture therein such that the interior of said housing is in fluidic communication with the exterior of said housing.

16. The illumination device of claim 1, wherein said synthetic jet ejector has a plurality of fins disposed on an external surface thereof.

17. The illumination device of claim 13, wherein said synthetic jet ejector is adapted to emit a synthetic jet into a channel formed by opposing fins of said plurality of fins.

18. An illumination device, comprising:
a housing;
a threaded connector adapted to rotatingly engage said illumination device to a source of electricity;
a synthetic jet actuator disposed in said connector;
a manifold disposed on said housing and having a plurality of apertures therein;
an LED disposed on said manifold; and
a conduit in fluidic communication with said manifold and said synthetic jet actuator.

19. The illumination device of claim 18, wherein said conduit is cylindrical in shape.

20. The illumination device of claim 18, wherein said synthetic jet actuator has first and second diaphragms.

21. The illumination device of claim 18, wherein said synthetic jet actuator is a magneto-electrical device.

22. The illumination device of claim 18, wherein said synthetic jet actuator is a piezoelectric device.

23. The illumination device of claim 18, wherein said LED is disposed adjacent to at least one of said plurality of apertures.
